(19) United States
(12) Patent Application Publication
(10) Pub. No.: US 2017/0297699 A1
(43) Pub. Date: Oct. 19, 2017

(54) QUAD ROTOR TAIL-SITTER AIRCRAFT WITH ROTOR BLOWN WING (RBW) CONFIGURATION

(71) Applicant: Sikorsky Aircraft Corporation, Stratford, CT (US)

(72) Inventors: Mark R. Alber, Milford, CT (US); Jeffrey Parkhurst, Meriden, CT (US)

(21) Appl. No.: 15/335,523

(22) Filed: Oct. 27, 2016

Related U.S. Application Data
(60) Provisional application No. 62/248,681, filed on Oct. 30, 2015.

(51) Int. Cl. B64C 29/02; B64D 27/24; B64C 11/50; B64C 11/30; B64D 27/10; B64C 3/16; B64D 27/02

(52) U.S. Cl. CPC B64C 29/02; B64D 27/10; B64D 27/24; B64C 3/16; B64C 11/50; B64C 11/30; B64D 2027/026

(57) ABSTRACT

A tail-sitter aircraft is provided and includes a fuselage having first and second axisymmetric sides, first collectively controllable prop-rotors, which are formed to define a first pair of rotor disks and which are respectively supported at the first axisymmetric side of the fuselage, and second collectively controllable prop-rotors, which are formed to define a second pair of rotor disks and which are respectively supported at the second axisymmetric side of the fuselage.

### CROSS REFERENCE TO RELATED APPLICATIONS

This application claims the benefit of U.S. Provisional Application Ser. No. 62/248,681, filed Oct. 30, 2015, the entire disclosure of which is incorporated herein by reference.

### BACKGROUND OF THE DISCLOSURE

The subject matter disclosed herein relates to aircraft configurations and, more particularly, to quad rotor tail-sitter aircraft with a rotor blown wing (RBW) configuration.

Contemporary rotorcrafts typically use collective and cyclic controls for maintaining rotor flight control. Where such rotorcrafts have RBW configurations, the wing is used for control in hover and forward flight operations as serves as the key lift device for cruise. Quad rotor helicopters, on the other hand, use differential torque and thrust/collective controls on each of the rotors as the main rotor control elements. The rotors are thus used as the key lift device for cruise and do not necessarily require cyclic control capability.

### BRIEF DESCRIPTION OF THE DISCLOSURE

According to one aspect of the disclosure, a tail-sitter aircraft is provided and includes a fuselage having first and second axisymmetric sides, first collectively controllable prop-rotors, which are formed to define a first pair of rotor disks and which are respectively supported at the first axisymmetric side of the fuselage, and second collectively controllable prop-rotors, which are formed to define a second pair of rotor disks and which are respectively supported at the second axisymmetric side of the fuselage.

According to alternative or additional embodiments, the tail-sitter aircraft further includes alighting elements disposed to provide nose-up, tail-sitter aircraft support during ground operations.

According to alternative or additional embodiments, the tail-sitter aircraft further includes at least one of a gas turbine engine, an electrical motor-generator and a hybrid engine to generate power to drive operations of the first and second collectively controllable prop-rotors.

According to alternative or additional embodiments, at least one or more of the first and second collectively controllable prop-rotors is cyclically controllable.

According to alternative or additional embodiments, the first pair of rotor disks overlap and the second pair of rotor disks overlap and the tail sitter aircraft further includes a drive system coupled to the first and second collectively controllable prop-rotors to synchronize respective operations of the first and second overlapped pairs of rotor disks.

According to alternative or additional embodiments, the tail-sitter aircraft further includes first and second wings extending from the first and second axisymmetric sides of the fuselage, respectively, and first and second sets of spires to support the first and second collectively controllable prop-rotors at offset positions along the first and second wings, respectively.

According to alternative or additional embodiments, the tail-sitter aircraft further includes a single wing extending beyond the first and second axisymmetric sides of the fuselage and along which the first and second collectively controllable prop-rotors are supportable.

According to alternative or additional embodiments, ends of the single wing are angled with respect to proximal ends of the single wing.

According to alternative or additional embodiments, the distal ends are one of dihedral and anhedral.

According to alternative or additional embodiments, the tail-sitter aircraft further includes a first wing extending from the first axisymmetric side of the fuselage and along which a first one of the first collectively controllable prop-rotors is supportable, a second wing extending from the first axisymmetric side of the fuselage and along which a second one of the first collectively controllable prop-rotors is supportable, a first wing extending from the second axisymmetric side of the fuselage and along which a first one of the second collectively controllable prop-rotors is supportable and a second wing extending from the second axisymmetric side of the fuselage and along which a second one of the second collectively controllable prop-rotors is supportable.

According to alternative or additional embodiments, the first wings are one of anhedral and dihedral and the second wings are one of dihedral and anhedral.

According to yet another aspect of the disclosure, a tail-sitter aircraft is provided and includes a fuselage having first and second axisymmetric sides, first collectively controllable prop-rotors, which are formed to define a first overlapped pair of rotor disks and which are respectively supported in a rotor blown wing (RBW) configuration at the first axisymmetric side of the fuselage, second collectively controllable prop-rotors, which are formed to define a second overlapped pair of rotor disks and which are respectively supported in an RBW configuration at the second axisymmetric side of the fuselage, and a drive system coupled to the first and second collectively controllable prop-rotors to synchronize respective operations of the first and second overlapped pairs of rotor disks.

According to alternative or additional embodiments, the tail-sitter aircraft further includes first and second wings extending from the first and second axisymmetric sides of the fuselage, respectively, and first and second sets of spires to support the first and second collectively controllable prop-rotors at offset positions along the first and second wings, respectively.

According to alternative or additional embodiments, the tail-sitter aircraft further includes a single wing extending beyond the first and second axisymmetric sides of the fuselage and along which the first and second collectively controllable prop-rotors are supportable.

According to alternative or additional embodiments, the tail-sitter aircraft further includes a first wing extending from the first axisymmetric side of the fuselage and along which a first one of the first collectively controllable prop-rotors is supportable, a second wing extending from the first axisymmetric side of the fuselage and along which a second one of the first collectively controllable prop-rotors is supportable, a first wing extending from the second axisymmetric side of the fuselage and along which a first one of the second collectively controllable prop-rotors is supportable and a second wing extending from the second axisymmetric side of the fuselage and along which a second one of the second collectively controllable prop-rotors is supportable.

These and other advantages and features will become more apparent from the following description taken in conjunction with the drawings.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a perspective view of a tail-sitter aircraft;

FIG. 2 is a front view of a tail sitter aircraft in accordance with embodiments;

FIG. 3 is a front view of a tail sitter aircraft in accordance with alternative embodiments;

FIG. 4 is a front view of a tail sitter aircraft in accordance with alternative embodiments;

FIG. 5 is a schematic illustration of a drive shaft system in accordance with embodiments; and

FIG. 6 is a schematic illustration of a drive shaft system in accordance with alternative embodiments.

The detailed description explains embodiments of the disclosure, together with advantages and features, by way of example with reference to the drawings.

### DETAILED DESCRIPTION OF THE DISCLOSURE

As will be described below, a vertical take-off and landing (VTOL) or short take-off and landing (STOL) tail-sitter aircraft is provided. The tail-sitter aircraft has quad-rotor technology in a rotor blown wing (RBW) configuration. In particular, two rotors are on opposite sides of the fuselage to provide for left/right and forward/aft differential thrust. The rotors may be electrically powered on engine powered using a drive system. Rotors that are overlapped use a drive system for synchronization.

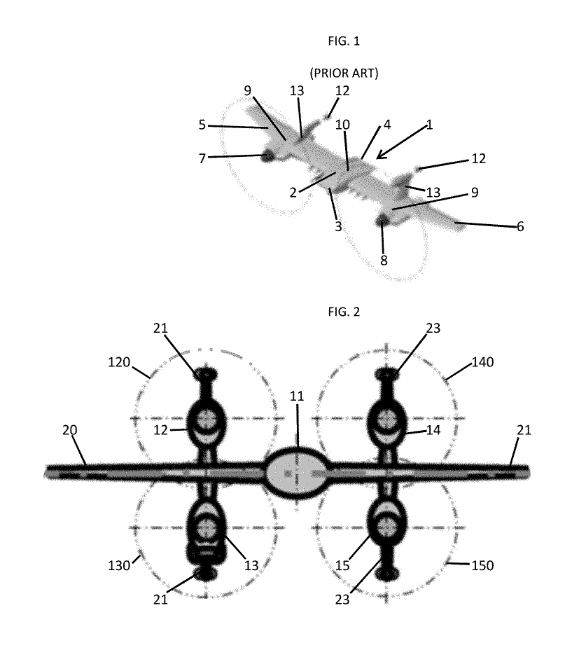

With reference to FIG. 1, a conventional tail-sitter aircraft 1 is illustrated. The tail-sitter aircraft 1 includes a fuselage 2 that has a nose (or forward) section 3 and a tail (or aft) section 4. The tail-sitter aircraft 1 also includes a first wing 5 that extends outwardly from a first side of the fuselage 2 and a second wing 6, opposite the first wing 5, which extends outwardly from the second side of the fuselage 2. A first prop-rotor 7 is supportively disposed along the first wing 5 and a second prop-rotor 8 is supportively disposed along the second wing 6. The first and second prop-rotors 7 and 8 may be collectively and cyclically controllable and are drivable such that their respective rotors rotate about respective rotational axes.

As used herein, the terms “first side of the fuselage 2” and “second side of the fuselage 2,” refer to axisymmetric sides of the fuselage 2. In other words, if the fuselage 2 were cut down its center line from top to bottom, the first and second sides of the fuselage 2 would be mirror opposites of one another.

When so driven during vertical take-off and landing (VTOL) operations and during hover operations, the first and second prop-rotors 7 and 8 generate thrust and lift for the tail-sitter aircraft 1. Conversely, when the first and second prop-rotors 7 and 8 are driven to rotate during horizontal, forward or cruise flight operations, they generate thrust. The first and second wings 5 and 6 provide for lift during the horizontal, forward or cruise flight operations.

The tail-sitter aircraft 1 may further include a power generating unit 9, a flight control computer 10, a payload 11 and alighting elements 12. The power generating unit 9 may be housed in the fuselage 2, the first wing 5, the second wing 6 and/or the first and second prop-rotors 7 and 8. In any case, the power generating unit 9 may be provided as a gas turbine engine, which is connected to the first and second prop-rotors 7 and 8 by a turbo-shaft, for example, an electrical motor-generator and a hybrid engine. The flight control computer 10 and the payload 11 may also be housed in the fuselage 2, the first wing 5, the second wing 6 and/or the first and second prop-rotors 7 and 8 whereby at least the flight control computer 10 controls various operations of the tail-sitter aircraft. The alighting elements 12 may be supported at offset positions along the first and second wings 5 and 6 by spires 13 and provide for support of the tail-sitter aircraft 1 during grounded conditions.

With reference to FIGS. 2-4, a quad rotor tail-sitter aircraft 10 with an RBW configuration in accordance with embodiments will now be described. The tail-sitter 10 includes several elements that are found in or are provided in common with the tail-sitter aircraft 1 of FIG. 1 and thus a further or repeated description of those elements will be omitted from the following descriptions. For clarity and brevity, however, it is to be understood that these elements include, but are not limited to, the power generating unit 9 (i.e., the gas turbine engine, the electrical motor-generator or the hybrid engine), the flight control computer 10, the payload 11 and the alighting elements 12.

As shown in FIGS. 2-4, the tail-sitter aircraft 10 includes a fuselage 11, first collectively controllable prop-rotors 12 and 13 and second collectively controllable prop-rotors 14 and 15. The first collectively controllable prop-rotors 12 and 13 are formed to define a first pair of rotor disks 120 and 130 and are respectively supported at a first side of the fuselage 11. The second collectively controllable prop-rotors 14 and 15 are formed to define a second pair of rotor disks 140 and 150 and are respectively supported at a second side of the fuselage 11.

By way of collective control being applied to the first and second collectively controllable prop-rotors 12 and 13 and 14 and 15, yaw, roll and pitch movements of the tail-sitter aircraft 10 may be achieved in both vertical flight operations and horizontal flight operations. For example, during a vertical take-off, the first and second collectively controllable prop-rotors 12 and 13 and 14 and 15 can all be collectively controlled to increase thrust needed to lift the tail-sitter 10 off the ground. Subsequently, a differential thrust command can be applied between the first collectively controllable prop-rotors 12 and 13 and between the second collectively controllable prop-rotors 14 and 15 (i.e., higher thrust command on first collectively controllable prop-rotor 12 and second collectively controllable prop-rotor 14 and lower thrust command on first collectively controllable prop-rotor 13 and second collectively controllable prop-rotor 15) to drive a pitch movement of the tail-sitter aircraft 10 so as to transition between vertical and horizontal flight. Thereafter, a differential thrust command can be applied between the first and second collectively controllable prop-rotors 12 and 13 and 14 and 15 (i.e., higher thrust command on first and second collectively controllable prop-rotors 12 and 13 and lower thrust command on second collectively controllable prop-rotors and 14 and 15) to drive a yaw movement of the tail-sitter aircraft 10 so as to execute a mid-flight course correction. In addition, a differential thrust command can be applied between the first collectively controllable prop-rotors 12 and 13 and an opposite differential thrust command can be applied between the second collectively controllable prop-rotors 14 and 15 to drive a roll movement of the tail-sifter aircraft 10 (i.e., higher thrust command on first collectively controllable prop-rotor 12 and second collectively controllable prop-rotor 15 and lower thrust command on first collectively controllable prop-rotor 13 and second collectively controllable prop-rotor 14).

In accordance with embodiments, at least one or more of the first and second collectively controllable prop-rotors 12 and 13 and 14 and 15 may also be cyclically controllable. Such cyclic control may be used, for example, during horizontal flight operations in cases where stringent yaw movements of the tail-sitter aircraft 10 are required.

As shown in FIG. 2, in particular, the tail-sitter aircraft 10 may include a first wing 20, a first set of spires 21, a second wing 22 opposite the first wing 20 and a second set of spires 23. The first wing 20 extends outwardly from a first side of the fuselage 11 and the second wing 21 extends outwardly from a second side of the fuselage 11.

Each spire 21 in the first set of spires 21 is disposable to support the first collectively controllable prop-rotors 12 and 13 at positions along the first wing 20 that are offset from a plane of the first wing 20. More particularly, a first one of the spires 21 is disposable to support a first one of the first collectively controllable prop-rotors 12 and 13 at a distance from a first (or upper) side of the first wing 20 and a second one of the spires 21 is disposable to support a second one of the first collectively controllable prop-rotors 12 and 13 at a distance from a second (or lower) side of the first wing 20.

Similarly, each spire 23 in the second set of spires 23 is disposable to support the second collectively controllable prop-rotors 14 and 15 at positions along the second wing 22 that are offset from a plane of the second wing 22. More particularly, a first one of the spires 23 is disposable to support a first one of the second collectively controllable prop-rotors 14 and 15 at a distance from a first (or upper) side of the second wing 22 and a second one of the spires 23 is disposable to support a second one of the second collectively controllable prop-rotors 14 and 15 at a distance from a second (or lower) side of the second wing 22.

The offset positions of the first and second collectively controllable prop-rotors 12 and 13 and 14 and 15 are defined based on axial lengths of the spires 21 and 23. That is, the longer the spires 21 and 23 are, the further the first and second collectively controllable prop-rotors 12 and 13 and 14 and 15 are offset from the respective planes of the first and second wings 20 and 22.

In accordance with embodiments, the alighting elements 12 of FIG. 1 may be disposed along the spires 21 and 23 to define a multiple-point support system for the tail-sitter aircraft 10.

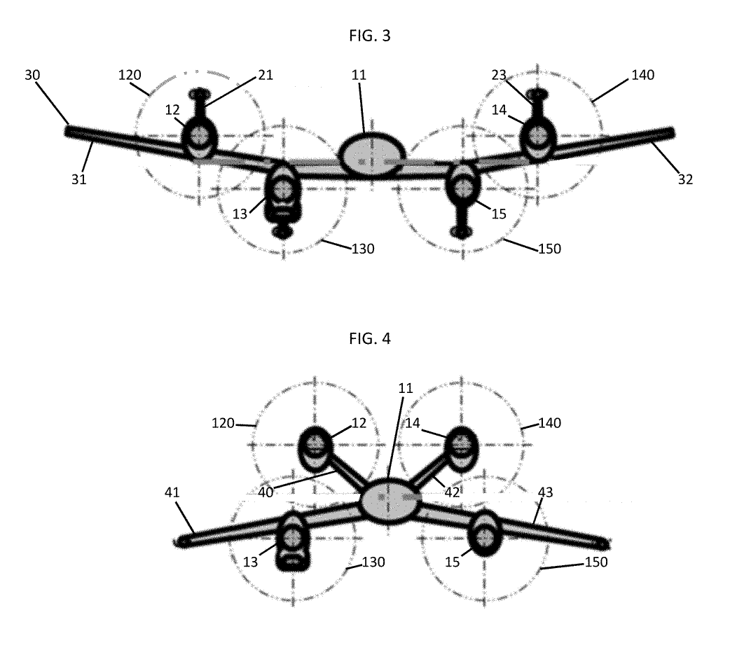

As shown in FIG. 3, the tail-sitter aircraft 10 may include a single wing 30 that has a first wing portion 31, a second wing portion 32 and a connector portion 33 that connects the first and second wing portions 31 and 32 proximate to the fuselage 11. The first wing portion 31 extends beyond the first side of the fuselage 11 and the second wing portion 32 extends beyond the second side of the fuselage 11. The first collectively controllable prop-rotors 12 and 13 are supportable along the first wing portion 31 and the second collectively controllable prop-rotors 14 and 15 are supportable along the second wing portion 32.

In accordance with embodiments, distal end of the single wing 30 may be angled. That is, the distal end of the first wing portion 31 may be angled with respect to a plane of a proximal end of the first wing portion 31 and the distal end of the second wing portion 32 may be angled with respect to a plane of a proximal end of the second wing portion 32. More particularly, the distal ends of the single wing 30 may be dihedral (see FIG. 3) or anhedral.

In accordance with embodiments, the spires 21 and 23 may extend from exterior surfaces of the first and second collectively controllable prop-rotors 12 and 13 and 14 and 15. Thus, the alighting elements 12 of FIG. 1 may be disposed along the spires 21 and 23 to again define a multiple-point support system for the tail-sitter aircraft 10.

As shown in FIG. 4, the tail-sitter aircraft 10 may include a first wing 40, a second wing 41, a third wing 42 and a fourth wing 43. The first wing 40 extends from the first side of the fuselage 11 and is supportive of a first one of the first collectively controllable prop-rotors 12 and 13. The second wing 41 extends from the first side of the fuselage 11 and is supportive of a second one of the first collectively controllable prop-rotors 12 and 13. The third wing 42 extends from the second side of the fuselage 11 and is supportive of a first one of the second collectively controllable prop-rotors 14 and 15. The fourth wing 43 extends from the second side of the fuselage 11 and is supportive of a second one of the second collectively controllable prop-rotors 14 and 15. The first and third wings 40 and 42 may be anhedral and the second and fourth wings 41 and 43 may be dihedral (see FIG. 4) although it is to be understood that the first and third wings 40 and 42 may be dihedral and that the second and fourth wings 41 and 43 may be anhedral.

In accordance with embodiments, the alighting elements 12 of FIG. 1 may be disposed along the first-fourth wings 40-43 to again define a multiple-point support system for the tail-sitter aircraft 10.

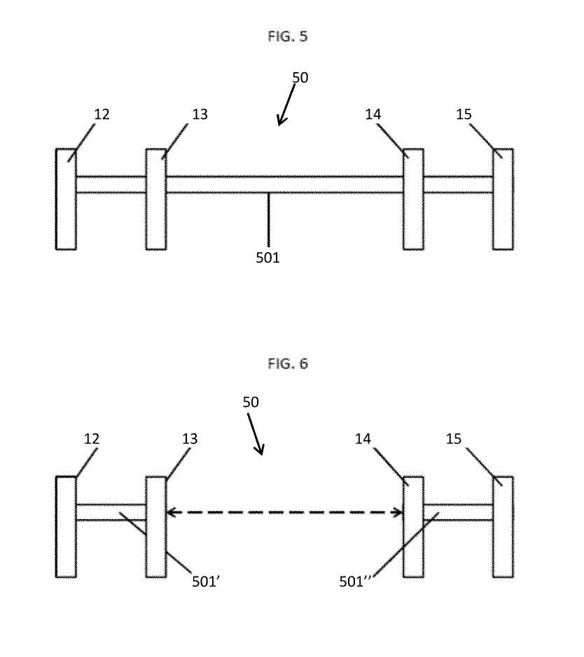

For each of the embodiments of FIGS. 2-4 and, with reference to FIGS. 5 and 6, it is to be understood that the first pair of rotor disks 120 and 130 may be but are not required to be overlapped with one another and that the second pair of rotor disks 140 and 150 may also be but are not required to be overlapped with one another. In such cases, the tail sitter aircraft 10 may include a drive system 50 that is coupled to the first and second collectively controllable prop-rotors 12 and 13 and 14 and 15 to synchronize respective operations of the first and second pairs of rotor disks 120 and 130 and 140 and 150.

The drive system 50 may be housed in at least one or more of the fuselage 11 and the wing elements of FIGS. 2-4. In accordance with embodiments, the drive system 50 may reside in a volume of leading edges of the wing elements of FIGS. 2-4. In any case, the drive system 50 may include a cross-shaft 501 by which the timing of the rotations of the first and second collectively controllable prop-rotors 12 and 13 and 14 and 15 can be controlled in order to reduce or eliminate the risk of rotor blade interference or impacts. In accordance with embodiments, the cross-shaft 501 may be provided as a single cross-shaft 501 (see FIG. 5) or as first and second cross-shafts 501′ and 501″ (see FIG. 6) that are respectively contained within wing elements. In the latter case, the first and second cross-shafts 501′ and 501″ may be coupled to one another by way of a transmission or central shaft system.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements and/or components, but do not preclude the presence or addition of one or more other features, integers, steps, operations, element components and/or groups thereof.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A tail-sitter aircraft, comprising:
a fuselage having first and second axisymmetric sides;
first collectively controllable prop-rotors, which are formed to define a first pair of rotor disks and which are respectively supported at the first axisymmetric side of the fuselage; and
second collectively controllable prop-rotors, which are formed to define a second pair of rotor disks and which are respectively supported at the second axisymmetric side of the fuselage.

2. The tail-sitter aircraft according to claim 1, further comprising alighting elements disposed to provide nose-up, tail-sitter aircraft support during ground operations.

3. The tail-sitter aircraft according to claim 1, further comprising at least one of a gas turbine engine, an electrical motor-generator and a hybrid engine to generate power to drive operations of the first and second collectively controllable prop-rotors.

4. The tail-sitter aircraft according to claim 1, wherein at least one or more of the first and second collectively controllable prop-rotors is cyclically controllable.

5. The tail-sitter aircraft according to claim 1, wherein the first pair of rotor disks overlap and the second pair of rotor disks overlap, the tail sitter aircraft further comprising a drive system coupled to the first and second collectively controllable prop-rotors to synchronize respective operations of the first and second overlapped pairs of rotor disks.

6. The tail-sitter aircraft according to claim 1, further comprising:
first and second wings extending from the first and second axisymmetric sides of the fuselage, respectively;
first and second sets of spires to support the first and second collectively controllable prop-rotors at offset positions along the first and second wings, respectively.

7. The tail-sitter aircraft according to claim 1, further comprising a single wing extending beyond the first and second axisymmetric sides of the fuselage and along which the first and second collectively controllable prop-rotors are supportable.

8. The tail-sitter aircraft according to claim 7, wherein distal ends of the single wing are angled with respect to proximal ends of the single wing.

9. The tail-sitter aircraft according to claim 8, wherein the distal ends are one of dihedral and anhedral.

10. The tail-sitter aircraft according to claim 1, further comprising:
a first wing extending from the first axisymmetric side of the fuselage and along which a first one of the first collectively controllable prop-rotors is supportable;
a second wing extending from the first axisymmetric side of the fuselage and along which a second one of the first collectively controllable prop-rotors is supportable;
a first wing extending from the second axisymmetric side of the fuselage and along which a first one of the second collectively controllable prop-rotors is supportable; and
a second wing extending from the second axisymmetric side of the fuselage and along which a second one of the second collectively controllable prop-rotors is supportable.

11. The tail-sifter aircraft according to claim 10, wherein the first wings are one of anhedral and dihedral and the second wings are one of dihedral and anhedral.

12. A tail-sifter aircraft, comprising:
a fuselage having first and second axisymmetric sides;
first collectively controllable prop-rotors, which are formed to define a first overlapped pair of rotor disks and which are respectively supported in a rotor blown wing (RBW) configuration at the first axisymmetric side of the fuselage;
second collectively controllable prop-rotors, which are formed to define a second overlapped pair of rotor disks and which are respectively supported in an RBW configuration at the second axisymmetric side of the fuselage; and
a drive system coupled to the first and second collectively controllable prop-rotors to synchronize respective operations of the first and second overlapped pairs of rotor disks.

13. The tail-sitter aircraft according to claim 12, further comprising:
first and second wings extending from the first and second axisymmetric sides of the fuselage, respectively;
first and second sets of spires to support the first and second collectively controllable prop-rotors at offset positions along the first and second wings, respectively.

14. The tail-sifter aircraft according to claim 12, further comprising a single wing extending beyond the first and second axisymmetric sides of the fuselage and along which the first and second collectively controllable prop-rotors are supportable.

15. The tail-sitter aircraft according to claim 12, further comprising:
a first wing extending from the first axisymmetric side of the fuselage and along which a first one of the first collectively controllable prop-rotors is supportable;
a second wing extending from the first axisymmetric side of the fuselage and along which a second one of the first collectively controllable prop-rotors is supportable;
a first wing extending from the second axisymmetric side of the fuselage and along which a first one of the second collectively controllable prop-rotors is supportable; and
a second wing extending from the second axisymmetric side of the fuselage and along which a second one of the second collectively controllable prop-rotors is supportable.
